(19) United States
(12) Patent Application Publication
(10) Pub. No.: US 2022/0341962 A1
(43) Pub. Date: Oct. 27, 2022

(54) CHILD PRESENCE DETECTION IN A CAR

(71) Applicant: Cerence Operating Company, Burlington, MA (US)

(72) Inventor: Nils Lenke, Aachen (DE)

(21) Appl. No.: 17/760,815

(22) PCT Filed: Sep. 28, 2020
(86) PCT No.: PCT/US2020/053051

§ 371 Date: Mar. 16, 2022

Related U.S. Application Data
(60) Provisional application No. 62/908,076, filed on Sep. 30, 2019.

(51) Int. Cl. G01P 13/00; G01P 15/18; G06V 20/59

(52) U.S. Cl. CPC G01P 13/00; G01P 15/18; G06V 20/59

(57) ABSTRACT

A system for detecting the presence of a person in an automobile includes a computing device and a microelectromechanical system (MEMS) sensor integrated into the automobile and configured to generate sensor data representing movement of the person in the automobile, the MEMS sensor being in operative communication with the computing device. The computing device is configured to process the sensor data from the MEMS sensor to detect the presence of a person in the automobile when the automobile is parked.

### CROSS-REFERENCES TO RELATED APPLICATIONS

This application claims the benefit of U.S. Provisional Application No. 62/908,076 filed Sep. 30, 2019, the contents of which are incorporated by reference herein.

### BACKGROUND OF THE INVENTION

The present disclosure relates to a system and a method for detecting the presence of a person in an automobile. More particularly, the present disclosure relates to an infant or child presence detection device.

Referring to FIG. 1, about 40 children die every year in the United States below because they are left behind in a car. Legislation is in preparation in the Unites States and in Europe that would make it mandatory for manufacturers to put detection systems into their cars that are capable of detecting left behind children and alerting the caretakers and/or authorities of the situation. Referring to FIG. 2, for example, Euro NCAP has requirements for putting detection systems into vehicles on its roadmap for the year 2022.

Some solutions to the detection of people in automobiles exist but are generally prone to errors. For example, camera-based solutions exist, but do not work if the child is not in a line of sight of the camera (e.g., the line of sight to the child is obstructed by a blanket covering the child).

Some solutions have user acceptance problems. For example, radar-based solutions may be able to detect breathing movements of the chest of a person in a vehicle. However, using active radar has acceptance problems by drivers because radiation, however small in amount, is present.

### SUMMARY OF THE INVENTION

Aspects described herein provide a system and/or a method to detect if there is a human in a car when the car is locked and should be empty.

One general aspect uses MEMS sensors (e.g., MEMS accelerometers) attached to either a child's car seat, a seat of an automobile, or a latch system of an automobile (e.g., an ISOFIX mechanism) to sense movement (e.g., general movement of the person or specific movements such as movements related to the person's heart rate). The sensed movement (or lack thereof) is used to determine whether a person (typically an infant) is in the automobile when the automobile is stationary and to alert others (e.g., caregivers or authorities) that the person may have been inadvertently left in the automobile unattended.

In a general aspect, a system for detecting the presence of a person in an automobile includes a computing device and a microelectromechanical system (MEMS) sensor integrated into the automobile and configured to generate sensor data representing movement of the person in the automobile, the MEMS sensor being in operative communication with the computing device. The computing device is configured to process the sensor data from the MEMS sensor to detect the presence of a person in the automobile when the automobile is parked.

Aspects may include one or more of the following features.

The MEMS sensor may be integrated into in the ISOFIX mechanism of the automobile. The MEMS sensor may be integrated into a seat of the automobile. The MEMS sensor may include an accelerometer. The accelerometer may be a 1-axis or a 3-axis accelerometer. The MEMS sensor may include a strain sensor. The MEMS sensor may include a pressure sensor. Processing the sensor data may include removing a signal component related to motion of the automobile from the sensor data while preserving a signal component. Removing the signal component related to the motion of the automobile form the sensor data may include removing at least some of the signal component related to the motion of the automobile after the automobile is parked.

The computing device may be configured to generate an alert if the presence of the person is detected. The sensor data may include image or video data from an image capture device. Processing the sensor data to detect the person may include processing the image or video data. The MEMS sensor may communicate wirelessly with the computing device.

In another general aspect, a method for detecting the presence of a person in an automobile includes receiving, at a computing device, sensor data representing movement of the person in the automobile from a microelectromechanical system (MEMS) sensor integrated into the automobile and processing, using the computing device, the sensor from the MEMS sensor to detect the presence of a person in the automobile when the automobile is parked.

In another general aspect, a non-transitory computer-readable medium has software embodied thereon, the software including instructions for causing a computing device to perform a method for detecting the presence of a person in an automobile. The method includes receiving sensor data representing movement of the person in the automobile from a microelectromechanical system (MEMS) sensor integrated into the automobile and processing the sensor from the MEMS sensor to detect the presence of a person in the automobile when the automobile is parked.

Among other advantages, aspects described herein do not suffer from line of sight disadvantages such as those associated with camera-based solutions. Aspects also advantageously do not require emission of radiation to operate, obviating certain consumer concerns. Positioning of sensors as described herein advantageously results in improved transmission and detection of motion-based signals from a seat in an automobile.

Other features and advantages of the invention are apparent from the following description, and from the claims.

### BRIEF DESCRIPTION OF THE DRAWINGS

FIG. 1 is a graph of US heat stroke deaths.

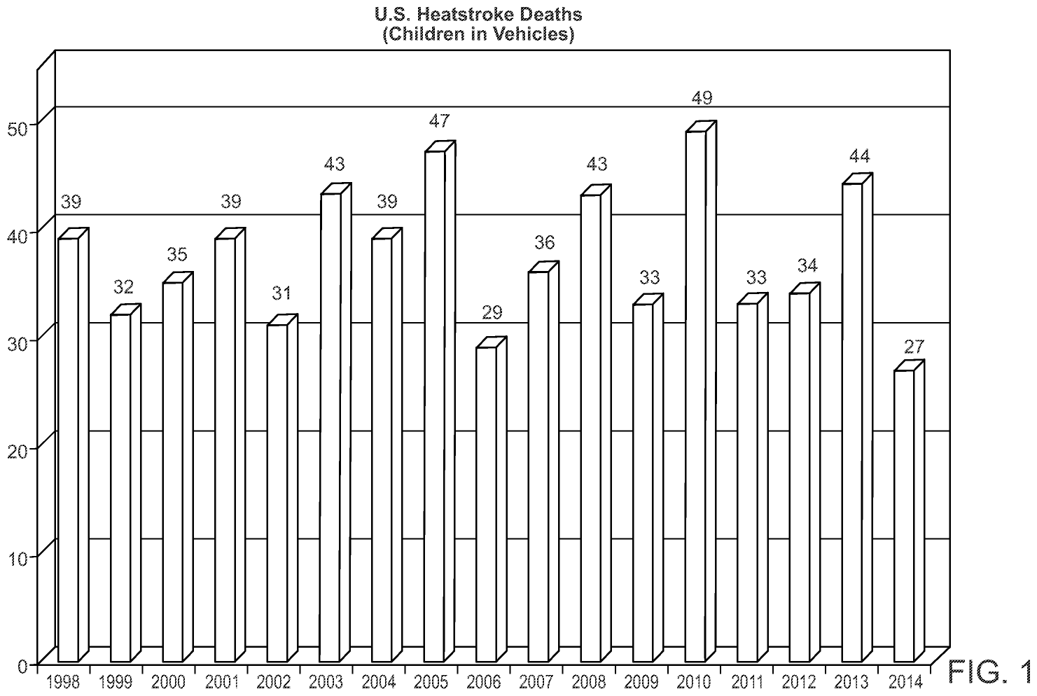

FIG. 2 is a Euro NCAP roadmap through the year 2025.

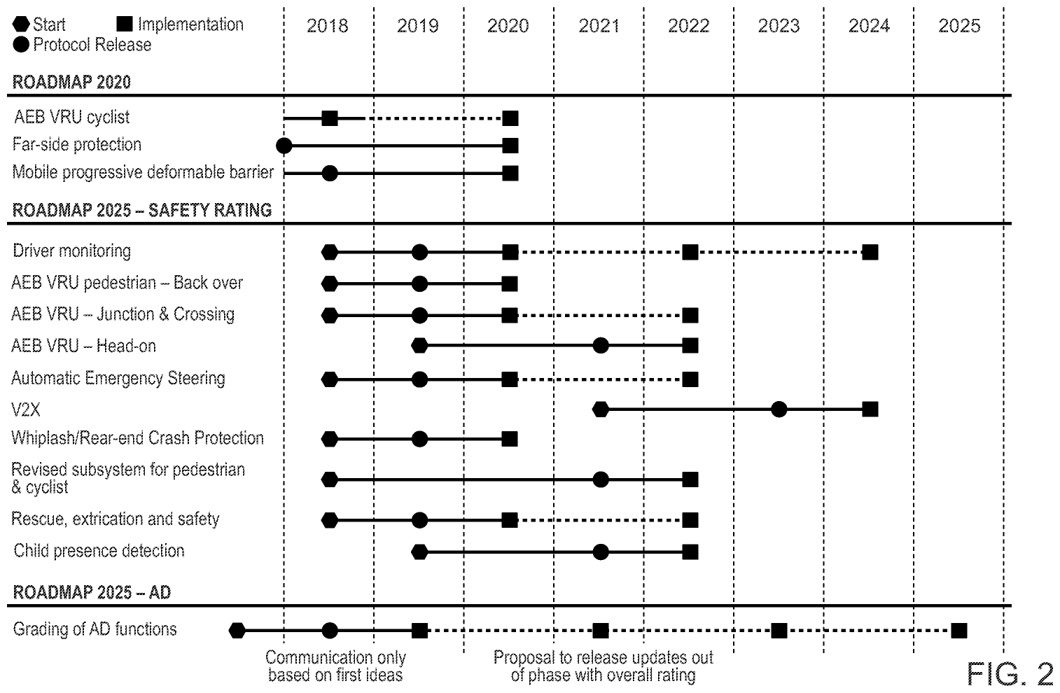

FIG. 3 is a perspective sideview of the system of the present disclosure.

FIG. 4 is test data from a parked car.

FIG. 5 is further test data from a parked car.

FIG. 6 is yet further test data from a parked car.

FIG. 7 is still further test data from a parked car.

FIG. 8 is a graph of measured vibrations of a running car.

FIG. 9 is a hardware diagram according to the present disclosure.

### DETAILED DESCRIPTION

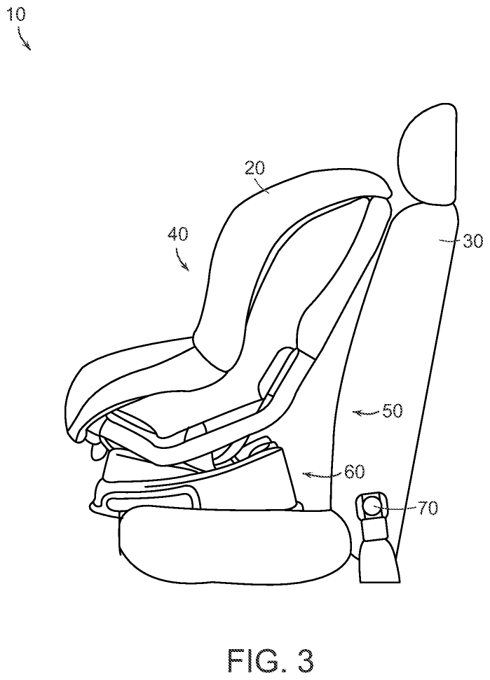

Referring to FIG. 3, a child presence detection device 10 includes one or more microelectromechanical systems (MEMS) sensors 40, 50 and/or 60 disposed in, on, or around a car seat 20 or child seat 30 in an automobile (not shown). The MEMS sensor(s) 40, 50, 60 are in communication (e.g., wireless or wired communication) with a computing device 1000.

Very generally, the computing device 1000 receives sensor data from one or more of the MEMS sensor(s) 40, 50, 60 and processes the sensor data to determine whether a person, and particularly a child, is present in the automobile. In the event that a person (e.g., a child) is present in the automobile and it is determined that the person has been left unattended, the computing device 1000 alerts the driver, the automobile operator, and/or authorities such as the police and fire department of the situation. Such an alert is intended to prevent the driver or automobile operator from accidently leaving the person behind in a locked automobile and to further ensure that the person left in the car is rescued if the driver or automobile operator does not respond.

As is shown in FIG. 3, a MEMS sensor 40 can be disposed in or on a child seat 20, a MEMS sensor 50 can be disposed in or on a seat 30 of the automobile, and/or a MEMS sensor 60 can be affixed to an ISOFIX (sometimes referred to as “latch”) mechanism of the car. In some examples, the MEMS sensor 40 in the child seat is installed in the liner of the child seat 20, in the body of the child seat 20, or in the harness of the child seat 20. In some examples, the MEMS sensor 50 in the seat 30 is installed in the seat itself, in the headrest, or in the seatbelt or seatbelt hardware 70. In some examples the MEMS sensor 60 affixed to the ISOFIX mechanism is installed in the ISOFIX hardware of the automobile (e.g., a motion or pressure sensor is coupled to the metal attachment mechanisms of the automobile) or to ISOFIX hardware of the child seat (e.g., the mechanism of the child seat used to interface with the ISOFIX hardware of the automobile), or both.

In some examples, MEMS sensors 40, 50 and/or 60 are identical MEMS sensors while in other some examples, there is variation among MEMS sensors 40, 50 and/or 60.

In general, MEMS sensors are made up of component sizes between 1 and 100 micrometers. MEMS sensors are very sensitive sensors that can capture very small movements and/or force or pressure variations. In microphones, MEMS sensors detect sound waves. In medical devices, MEMS sensors detect vital signs by exploiting ballistocardiography (B C G) signals.

In some examples, the MEMS sensors 40, 50 and/or 60 are 1-axis MEMS sensors. The present disclosure has found that such a 1-axis MEMS sensor can pick up signals when attached to various positions of in the automobile such as indicated by the arrows pointing to MEMS sensors 40, 50, and 60 in FIG. 3. In other examples, a 3-axis MEMS sensor (e.g. accelerometer) can be used.

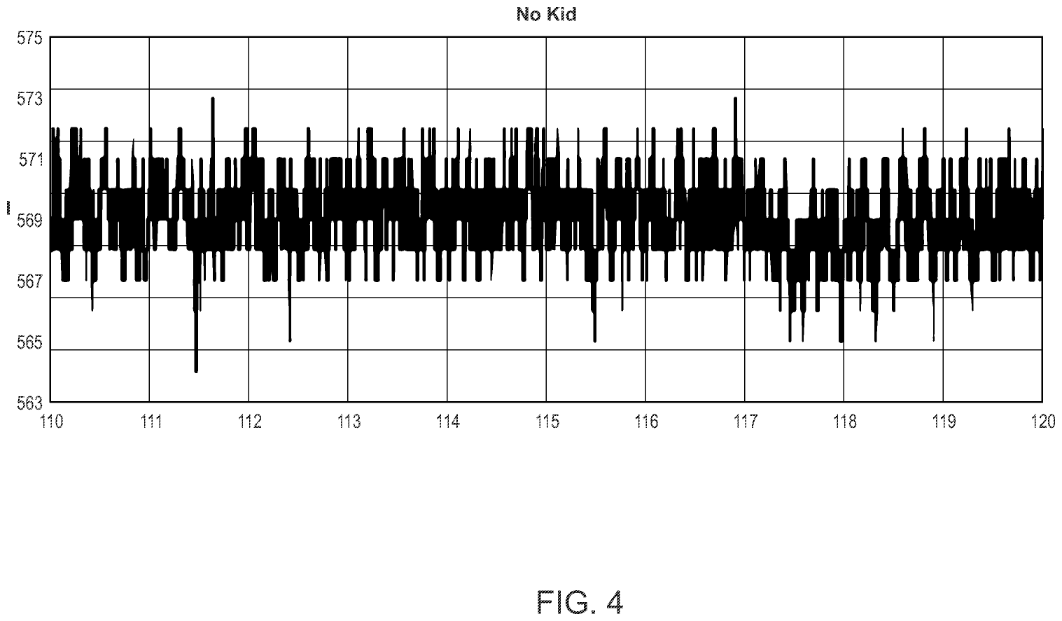

Referring to FIGS. 4-8, sensor data from MEMS sensors placed as indicated in FIG. 3 was collected while a person was present in a parked automobile. As is described in greater detail below, the collected sensor data demonstrates that a heartbeat/motion signal can be detected in all three positions shown by the arrows in FIG. 3.

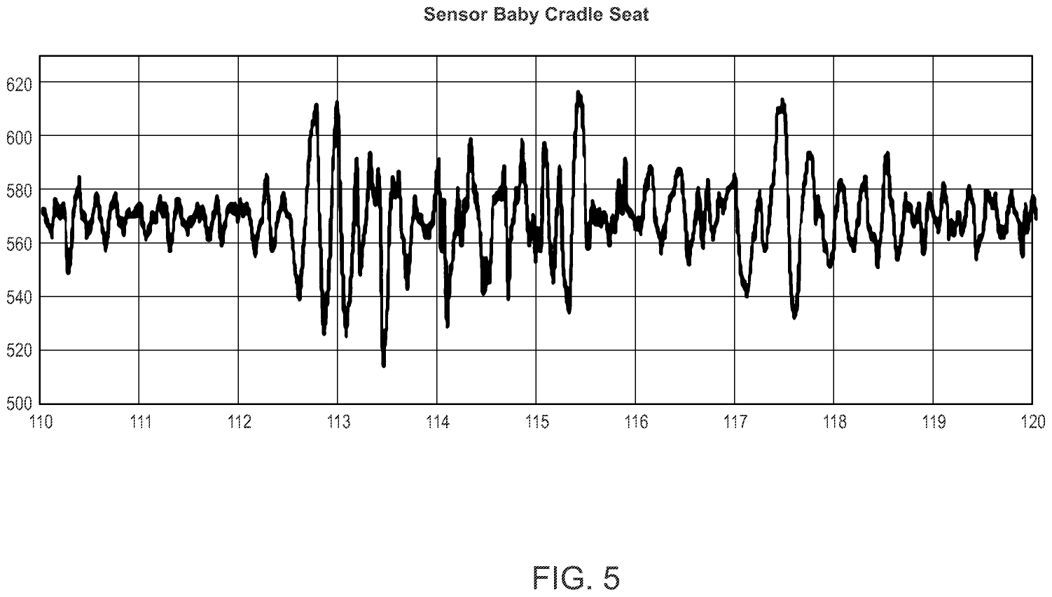

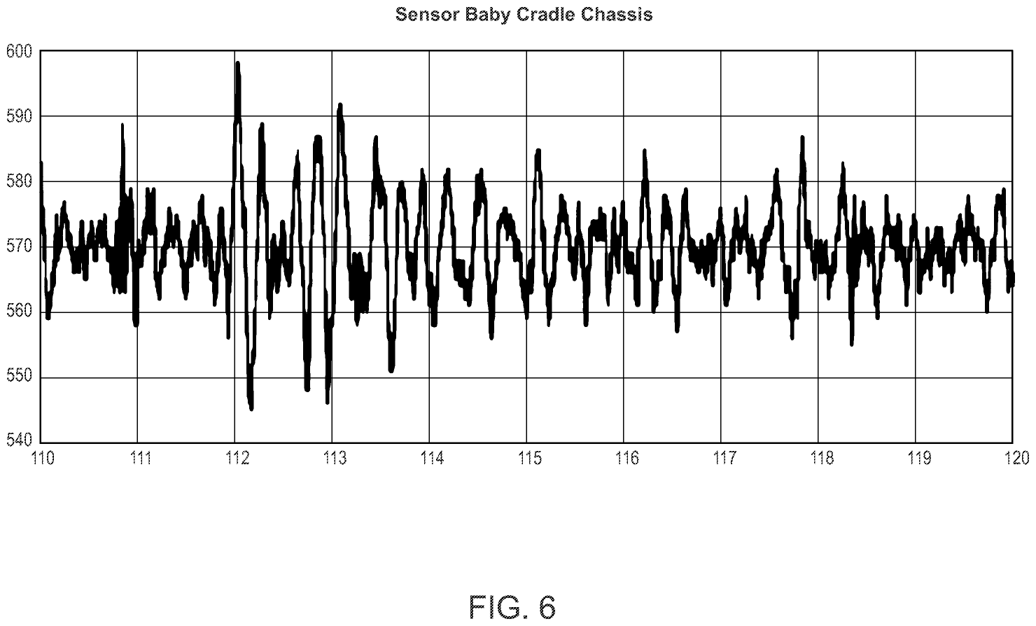

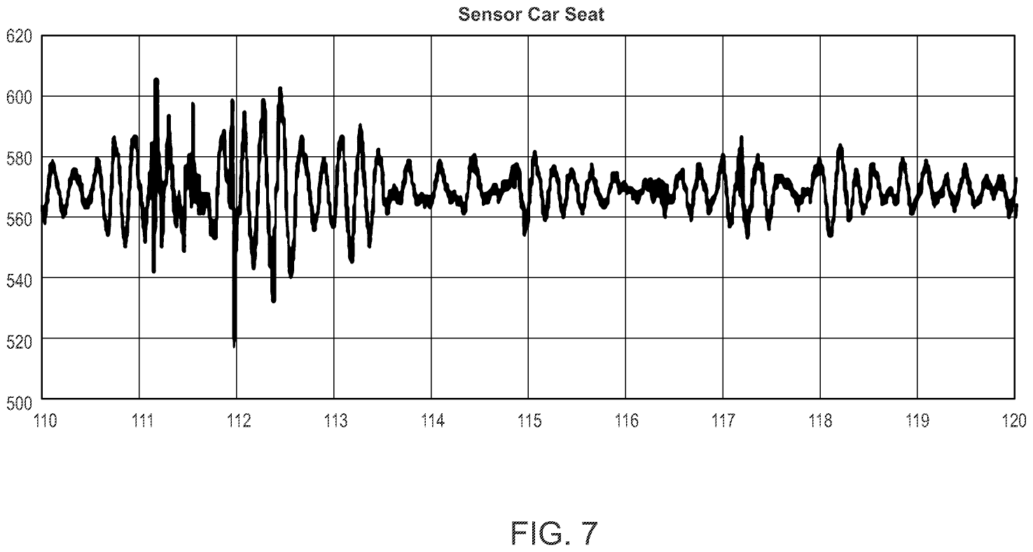

Referring to FIG. 4, with no person present in the automobile, the sensor data represents little to no motion and instead is mostly representative of sensor noise. Referring to FIG. 5, with an infant present in the automobile and a MEMS sensor 40 installed in the child seat 20, the sensor data represents motion (e.g., motion due to the infant's heartbeat or bodily movements). Referring to FIG. 6, with an infant present in the automobile and a MEMS sensor 60 installed in the in the ISOFIX hardware of the automobile (e.g., a motion or pressure sensor is coupled to the metal attachment mechanisms of the automobile) or to ISOFIX hardware of the child seat (e.g., the mechanism of the child seat used to interface with the ISOFIX hardware of the automobile), or both, the sensor data represents motion (e.g., motion due to the infant's heartbeat or bodily movements). Referring to FIG. 7, with an infant present in the automobile and a MEMS sensor 50 installed in the seat of the vehicle, the sensor data represents motion (e.g., motion due to the infant's heartbeat or bodily movements).

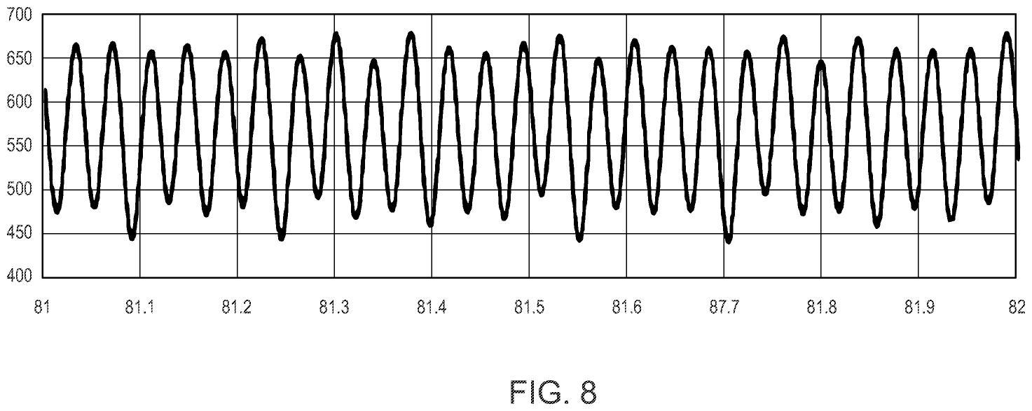

In some examples, when the automobile is running, vibration/noise is created that is also represented in the data collected by the MEMS sensors 40, 50 and/or 60. Referring to FIG. 8, sensor data measured vibrations as picked up by MEMS sensors 40, 50 and/or 60. IN some examples, the vibrations due to the running automobile take some time to stop, even after the engine of the automobile is shut down. As is described in greater detail below, in some examples, the sensor data is filtered to remove the effect of vibrations due to the running automobile.

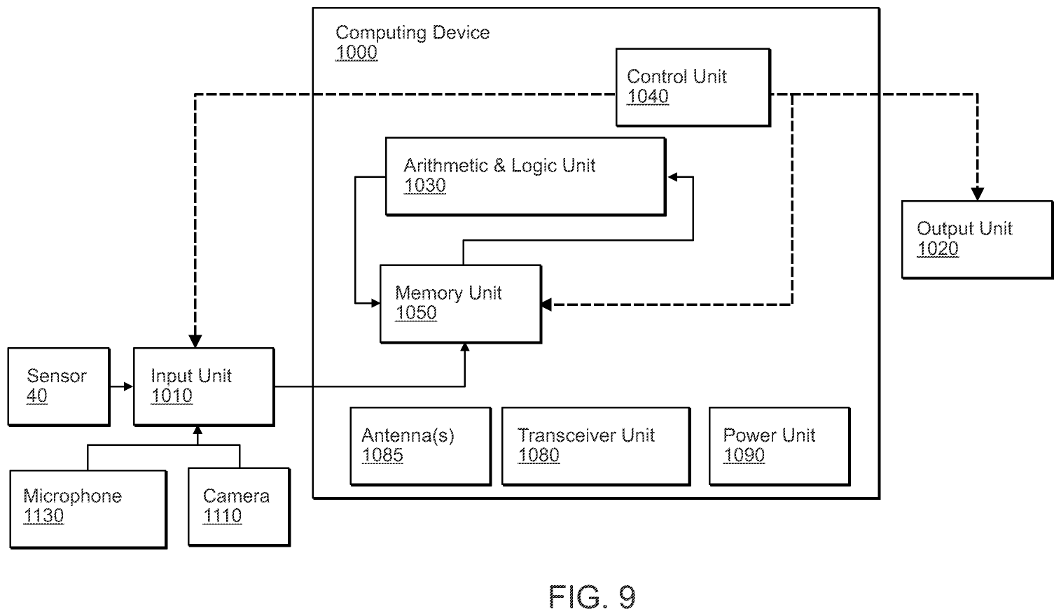

Referring to FIG. 9, an input unit 1010 receives input data (e.g., sensor data from the MEMS sensors 40, 50, 60, a camera 1110, and a microphone 1130) and provides the received input data to the computing device 1000. The computing device 1000 provides output data to an output unit 1020 for transmitting information or data to external devices. The computing device 1000 includes an arithmetic logic unit (ALU) 1030 that performs all arithmetic operations such as addition, subtraction, multiplication and division and uses logic operation for comparison. The computing device 1000 also includes a memory unit 1050 where data is stored. For example, memory unit 1050 stores instructions to be executed by processes according to the present disclosure. The computing device 100 also includes a control unit 1040 that controls input and output units 1010, 1020, the memory unit 1050, and other devices connected to or associated with the computing device 1000.

The computing device 1000 also includes a power unit 1090 for external power connection and a transceiver unit 1080 and antennas 1085 for wireless communication, for example, with for MEMS sensors 40, 50 or 60.

In some examples, the camera 1110 is an optical device that captures still or moving images. In some examples, the microphone 1130 is a transducer that converts sound into an electrical signal. Several types of microphones exist that use different techniques to convert, for example, air pressure variations of a sound wave into an electrical signal. Nonlimiting examples include dynamic microphones that use a coil of wire suspended in a magnetic field; condenser microphones that use a vibrating diaphragm as a capacitor plate and piezoelectric microphones that use a crystal made of piezoelectric material. A microphone according to the present disclosure can also include a radio transmitter and receiver for wireless applications.

In some examples, a MEMS sensor is placed inside of a car seat and detects a heartbeat whether or not the child is in child sear or cradle type device. In in some examples, a MEMS sensor is attached to the ISOFIX mechanism of the car seat. In some examples, the MEMS sensor is integrated into the automobile. In some examples, the automobile includes integrated connectors for connecting to the MEMS sensor(s). In some examples, the MEMS sensor(s) communicate with the automobile or another device (e.g., a dedicated receiver, a mobile device, or the automobile itself) using a wireless technology such as Bluetooth or WiFi networking.

In some examples, speech signal enhancement (SSE) noise reduction is performed using microphone 1130 and computing device 1000 to filter out car vibrations during engine operation. SSE noise reduction can also be used after stopping the engine since, as discussed above, some vibrations continue after the engine is turned off. Other types of filtering (e.g., notch filtering, band-pass filtering, or adaptive filtering) can also be used to remove signal components related to engine vibrations or other automobile vibrations from the sensor data.

The present disclosure envisions that additional MEMS sensors can be positioned at other locations in an automobile cabin to capture background noise. In some examples, a camera can be used in combination with the MEMS sensors to detect the presence of a passenger more accurately. In some examples, a microphone can be used in combination with the MEMS sensors to detect the presence of a passenger more accurately by monitoring breathing noises with a microphone. Device 10 is intended to detect if there is a human in the car when the car is locked and should be empty. Although device 10 can detect if a child, for example was inadvertently left in the car, the device can also be used to detect hidden car occupants, pets, etc.

### 1 Implementations

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1-16. (canceled)

17. An apparatus for detecting the presence of a person in an automobile, the apparatus comprising a computing device and a sensor, the sensor being configured to generate sensor data representing movement of the person in the automobile and being in operative communication with the computing device, wherein the computing device is configured to process the sensor data to detect the presence of a person in the automobile while the automobile is parked and wherein the sensor comprises a microelectromechanical system sensor that is integrated into the automobile.

18. The apparatus of claim 17, wherein the sensor is integrated into in an ISOFIX mechanism of the automobile.

19. The apparatus of claim 17, wherein the sensor is integrated into a seat of the automobile.

20. The apparatus of claim 17, wherein the sensor comprises an accelerometer.

21. The apparatus of claim 17, wherein the sensor comprises a single-axis accelerometer.

22. The apparatus of claim 17, wherein the sensor comprises a three-axis accelerometer.

23. The apparatus of claim 17, wherein the sensor comprises a strain sensor.

24. The apparatus of claim 17, wherein the sensor comprises a pressure sensor.

25. The apparatus of claim 17, wherein the computing device is configured to process the sensor data by removing a first signal component from the sensor data and retaining a second signal component from the sensor data, said first signal component being indicative of motion of the automobile and the second signal component not being indicative of motion of the automobile.

26. The apparatus of claim 17, wherein the computing device is configured to process the sensor data by removing, from the sensor data, a signal component that is indicative of the motion of the automobile, the signal component having been received after the automobile has been parked.

27. The apparatus of claim 17, wherein the computing device is further configured to generate an alert upon having detected the presence of the person.

28. The apparatus of claim 17, wherein the computing device is further configured to process data from an image capture device, wherein the data from the image capture device is representative of an image obtained from the image capture device.

29. The apparatus of claim 17, wherein the computing device is further configured to process data from an image capture device, wherein the data from the image capture device is representative of a video obtained from the image capture device.

30. The apparatus of claim 17, wherein the computing device is further configured to process data from an image capture device, said data being selected from the group consisting of an image and a video.

31. The apparatus of claim 17, wherein the sensor communicates wirelessly with the computing device.

32. The apparatus of claim 17, wherein said sensor is one of a plurality of MEMS sensors, wherein said MEMS sensors are of different types.

33. The apparatus of claim 17, wherein said motion is a heartbeat.

34. The apparatus of claim 17, wherein said motion is bodily motion.

35. A method for detecting the presence of a person in an automobile, the method comprising: receiving sensor data representing movement of the person in the automobile and processing the sensor data to detect the presence of a person in the automobile while the automobile is parked, wherein receiving the sensor data comprises receiving the sensor data from a microelectromechanical system sensor that is integrated into the automobile and wherein receiving the sensor data and processing the sensor data are both carried out by a computing device.

36. An article comprising a non-transitory computer-readable medium with software embodied thereon, the software comprising instructions for causing a computing device to perform a method for detecting the presence of a person in an automobile, the method comprising receiving sensor data representing movement of the person in the automobile from a microelectromechanical system and processing the sensor data to detect the presence of a person in the automobile while the automobile is parked, wherein receiving the sensor data comprises receiving the sensor data from a MEMS sensor integrated into the automobile.
